(19) United States
(12) Patent Application Publication
(10) Pub. No.: US 2025/0349008 A1
(43) Pub. Date: Nov. 13, 2025

(54) BLOOD-PRODUCT RECONCILIATION SYSTEM AND METHOD

(71) Applicant: Haemonetics Corporation, Boston, MA (US)

(72) Inventor: Melvin Tan, Boston, MA (US)

(21) Appl. No.: 19/202,555

(22) Filed: May 8, 2025

Related U.S. Application Data
(60) Provisional application No. 63/644,283, filed on May 8, 2024.

(51) Int. Cl. G06T 7/00; G06K 19/06

(52) U.S. Cl. CPC G06T 7/0014; G06K 19/06037; G06T 7/001

(57) ABSTRACT

A method and apparatus for managing blood products includes using an image system to capture an image of a container removably holding a plurality of vials containing a blood product, each vial having vial identifying indicia, the image system capturing the vial identifying indicia of each vial, the image system also capturing a visual attribute of the blood product. The captured identifying indicia of each vial is compared to a record having vial information related to the container, and the captured identifying indicia and vial information in the record is used to reconcile the container and plurality of vials to produce a reconciliation. A quality of the blood product as a function of the captured visual attribute is determined, a visual display of the results of the reconciliation and the quality of the blood product is logically produced and forwarded toward a display device.

### CROSS REFERENCE TO RELATED APPLICATIONS

This Application claims priority from U.S. Provisional Patent Application No. 63/644,283, filed May 8, 2024, the contents of which are incorporated by reference herein in its entirety as if fully set forth.

### FIELD

Illustrative embodiments of the invention generally relate to blood processing and, more particularly, various embodiments of the invention relate to reconciling and confirming requirements of blood products, such as plasma.

### BACKGROUND

Plasma donation is based on human donors in which whole blood is drawn from a donor and processed into individual blood components, such as plasma. A person who intends to donate plasma generally visits a plasma center where plasma center staff will examine and process the donor in accordance with the plasma center procedures until such time that the donor is deemed suitable or unsuitable for donating plasma.

Plasma centers use donor software to manage the entire donor process, including determining the suitability of a donor to donate plasma. Among other things, the donor software often tracks one or more of the processing, status, and movement of a donor as the donor is processed at each stage of the visit.

Plasma samples are stored in vials and labelled with some visual indicia (e.g., a bar code and unique identifier(s)) so they can be tracked through the system for last known location and lab test results. To ensure the integrity of the plasma, filled vials must be tested. This requires packaging and shipping samples to a test lab and therefore, includes a mailing manifest or other record with a detailed listing of every sample sent in that shipment. Current ways to complete this process are time consuming and error prone.

### SUMMARY OF VARIOUS EMBODIMENTS

In accordance with one embodiment, a method for managing blood products includes using an image system to capture an image of a container removably holding a plurality of vials containing a blood product, each vial having vial identifying indicia, the image system capturing the vial identifying indicia of each vial, the image system also capturing a visual attribute of the blood product; comparing the captured identifying indicia of each vial to a record having vial information related to the container; using the captured identifying indicia and vial information in the record to reconcile the container and plurality of vials to produce a reconciliation; determining a quality of the blood product as a function of the captured visual attribute; logically producing a visual display of the results of the reconciliation and the quality of the blood product; and forwarding the visual display toward a display device.

In some embodiments, the method further includes using the image system to capture a baseline image of the container removably holding the plurality of vials; and populating the record with the captured image from the other image, both acts of using the image system to capture the baseline image and populating occurring before reconciling.

In some embodiments, the blood product is plasma.

In some embodiments, the method further includes displaying the visual display on the display device.

In some embodiments, the visual display is configured to visually identify vials that are deemed to fail during reconciliation.

In some embodiments, a vial deemed to fail during reconciliation is visually different in the visual display than a vial not deemed to fail during reconciliation.

In some embodiments, the image comprising the container includes at least two or more of the plurality of vials.

In some embodiments, the identifying indicia comprises a bar code or QR code.

In accordance with one embodiment, a blood-product management system includes an input configured to receive a captured image from an image system, the captured image including a plurality of vials containing a blood product removably in a container, each vial having vial identifying indicia, the captured image having vial identifying indicia of each vial, the captured image also including a visual attribute of the blood product, and a data verification tool operatively coupled with the input. The data verification tool is configured to: compare the captured identifying indicia of each vial to a record having vial information related to the container, use the captured identifying indicia and vial information in the record to reconcile the container and plurality of vials to produce a reconciliation, determine a quality of the blood product as a function of the captured visual attribute, and logically produce a visual display of the results of the reconciliation and the quality of the blood product; and forward the visual display toward a display device.

In some embodiments, the system further includes the data capture tool configured to produce the record after receiving a baseline image of the container removably holding the plurality of vials and then populating the record.

In some embodiments, the blood product is plasma.

In some embodiments, the system further includes an image system and a display device to display the visual display.

In some embodiments, the visual display is configured to visually identify vials that are deemed to fail during reconciliation.

In some embodiments, a vial deemed to fail during reconciliation is visually different in the visual display than a vial not deemed to fail during reconciliation.

In some embodiments, the image comprising the container includes at least two or more of the plurality of vials.

In some embodiments, the identifying indicia comprises a bar code or QR code.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an image system capturing an image of a container holding a plurality of vials containing plasma in accordance with illustrative embodiments.

FIG. 2 schematically shows a management system configured in accordance with illustrative embodiments.

FIG. 3 shows a process of registering and managing vials of blood product, such as plasma, in accordance with illustrative embodiments.

FIG. 4 is an example block diagram of a device in accordance with illustrative embodiments.

### DESCRIPTION OF ILLUSTRATIVE EMBODIMENTS

Illustrative embodiments more effectively and efficiently prepare and process vials of blood products (e.g., plasma) for transfer to another location, such as a testing facility or hospital. To that end, an image system scans a plurality of vials contained in a container/package and rapidly confirms information (e.g., identification information) relating to the vials and their contents. At the same time or at a different time, some embodiments also determine a quality of the blood product using the same or another scan by the image system. Details of illustrative embodiments are discussed below.

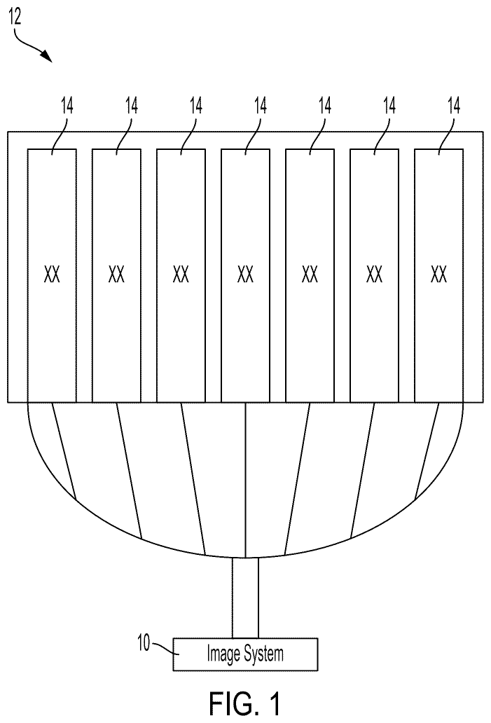

FIG. 1 schematically shows an image system 10 configured to capture an image of a container 12 holding a plurality of plasma-filled vials 14 in accordance with illustrative embodiments. As shown, the container 12 in this embodiment has seven vials 14 of a blood product (plasma in this embodiment). Each vial 14 is identified by unique visual identifying indicia, generally shown in the figure as “XX.”

The visual identification indicia on the vials 14 can encompass a variety of designs and technologies, each of which are uniquely structured to store and convey information effectively. Among the most recognizable are barcodes and QR codes, widely used in retail, manufacturing, and logistics. Barcodes are a series of parallel lines of varying widths and spacings, representing data by differing the patterns within these lines. A linear scan by a barcode reader typically translates the pattern into a readable format, typically numbers or letters. This simplicity and ease of use have made barcodes a ubiquitous tool for tracking inventory, managing point of sale systems, and a variety of other uses.

QR (Quick Response) codes represent a more advanced form of visual indicia, capable of storing more data in a two-dimensional matrix. They are formed from black squares arranged on a white square grid and can be scanned using a camera or a dedicated QR code reader. QR codes can encode a wide range of information types, from simple text or numbers to URLs, contact information, or even Wi-Fi network credentials. In illustrative embodiments, the QR codes can serve as a pointer or other mechanism to identify a database record with information relating to the vial 14 and its contents. The ability of a QR code to hold a significant amount of data in a compact space, along with their ease of use, has led to widespread adoption in advertising, contactless payment systems, and information sharing.

Rather than using an image system 10, alternative embodiments may use other types of visual or other identification indicia. For example, such other types of identification indicia include RFID (Radio-Frequency Identification) tags and NFC (Near Field Communication) technology, though these rely on radio waves rather than visual patterns. RFID tags store data that can be read from a distance using radio waves, making them useful for tracking goods in supply chain management or for use in access control systems. N FC, a subset of RFID, allows two devices to communicate when they are brought into close proximity and is commonly used in contactless payment systems and data transfer between devices. While not visually based like barcodes or QR codes, these technologies can play a significant role in the realm of digital identification and information exchange.

The container 12 removably secures the vials 14 and exposes some part of the vials 14 to the container exterior. A flap or other closing member (not shown) may be movable to alternatively expose the indicia/vials 14 and close the package. In illustrative embodiments, the package is a conventional “clamshell” package commonly used for transporting blood products.

Specifically, as known by those in the art, a clamshell package, commonly utilized in the transportation and storage of delicate items, offers both protection and convenience for transport of the vials 14. Characterized by its distinctive design, the package resembles the shape of a clamshell, featuring two hinged halves that virtually seamlessly close together. This design not only provides a robust protective shell, but also ensures ease of access to the contents. Typically crafted from durable plastic materials, clamshell packages often are transparent or semi-transparent, allowing for the easy identification of the contents without the necessity of opening the package. This feature is particularly beneficial in settings where quick visual verification is crucial, such as in medical or retail environments. Illustrative embodiments take advantage of this feature to image the indicia on the vials 14.

In the specific context of transporting vials 14 of blood products, the clamshell package plays a pivotal role in ensuring the safety and integrity of these sensitive specimens. The interior of the container 12 is often customized with compartments or molded fittings that snugly hold the vials 14, minimizing movement and the risk of breakage. This aspect is important as it not only protects the physical integrity of the vials 14, but also preserves the viability of the blood samples, which is important for accurate testing and analysis. Furthermore, the materials used in these packages often are resistant to chemicals and temperature fluctuations, adding another layer of protection against external conditions that could compromise the samples.

Beyond its practical applications, the design of clamshell packaging also adheres to stringent safety and compliance standards required for the transportation of biological materials. This compliance ensures that the packages not only physically safeguard the contents, but also align with health and safety protocols, minimizing the risk of contamination or spillage during transit. Accordingly, in this application, the clamshell container 12 facilitates efficient and safe transport of blood vials 14, ensuring that healthcare professionals can rely on the integrity of the samples for diagnostics, research, and treatment purposes.

Of course, while a clamshell container 12 is preferred, those skilled in the art may use other types of packages. Accordingly, discussion of a clamshell container 12 is exemplary and not intended to limit all embodiments of the invention.

As discussed in greater detail below, the image system 10 captures an image of the visual indicia of a plurality of the vials 14 in the container 12. Preferably, the image includes the visual indicia of all the vials 14 removably secured in the container 12. Other embodiments, however, may capture the visual indicia of some subset of the vials 14 (e.g., two to six vials 14). FIG. 1 shows a plurality of lines between the image system 10 and the container 12 to schematically show an exemplary region captured by the image system 10. As such, those lines are not physical components of the system.

The image system 10 may primarily be comprised of a basic or advanced camera configured to capture an image of the indicia. Other embodiments, however, may use more sophisticated image systems 10. As known by those in the art, an image system 10 typically includes a camera (of high-resolution or lower resolution, depending on the application) and image processing software. As shown in FIG. 1, the camera is strategically positioned to capture clear, detailed images of the vials 14 within the container 12. This setup allows for the identification of individual vials 14, verification of their contents, and assessment of their condition. Advanced features might include zoom capabilities and adjustable focus to adapt to vials 14 of different sizes or to capture finer details like labels or liquid levels.

Different types of image systems 10 can be employed based on the specific requirements of the task. One common type is the 2D image system 10, which captures flat images and is adept at measuring lengths and diameters, detecting presence or absence, and reading barcodes or labels. These systems are straightforward and cost-effective, making them suitable for applications where the requirements are relatively simple. Depending on their specifications, such image systems 10 may not be adept at capturing images from the cylindrical profile of a vial 14. As such, 3D image systems 10 may be employed. These systems can use lasers, structured light, or stereoscopic cameras to capture the three-dimensional structure of the objects, providing a comprehensive view that is crucial for more intricate analysis.

In the context of capturing images of vials 14, the choice between a 2D and 3D image system 10 depends on the level of detail required. For basic tasks like counting vials 14 or verifying labels (if flat enough), a 2D system may suffice. However, for more complex requirements, such as checking the volume of liquid in a vial 14 or ensuring proper cap placement, a 3D image system 10 may be more effective. These systems can accurately capture the contours and depth of each vial 14, providing a detailed analysis that ensures quality and consistency. Moreover, illustrative image systems 10 (aka “vision systems”) preferably can capture an image of the blood product itself for further processing (discussed below).

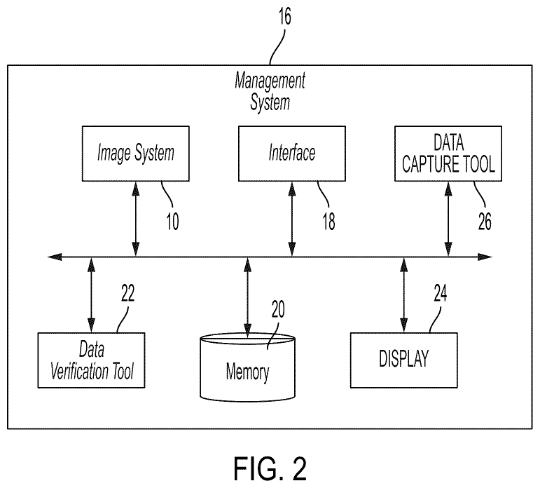

In illustrative embodiments, the image system 10 may be coupled with or considered part of a larger management system 16 that, among other things, registers the vials 14 into a manifest, confirms the contents of each vial 14 (using the visual indicia), and/or determines a quality of the blood product in each vial 14 as a function of some visual quality of the blood product in the vial 14. FIG. 2 schematically shows one embodiment of such a (blood product) management system 16. Each of these components in FIG. 2 is operatively connected by any conventional interconnect mechanism. While FIG. 2 simply shows a bus communicating each the components, those skilled in the art should understand that this generalized representation can be modified to include other conventional direct or indirect connections. Accordingly, discussion of a bus is not intended to limit various embodiments.

Indeed, it should be noted that FIG. 2 only schematically shows each of these components. Those skilled in the art should understand that each of these components can be implemented in a variety of conventional manners, such as by using hardware, software, or a combination of hardware and software, across one or more other functional components. For example, the data verification tool (discussed in detail below) may be implemented using a plurality of microprocessors executing firmware. As another example, the data verification tool may be implemented using one or more application specific integrated circuits (i.e., “ASICs”) and related software, or a combination of ASICs, discrete electronic components (e.g., transistors), and microprocessors. Accordingly, the representation of the data verification tool and other components in a single box of FIG. 2 is for simplicity purposes only. In fact, in some embodiments, the data verification tool of FIG. 2 is distributed across a plurality of different machines—not necessarily within the same housing or chassis.

It should be reiterated that the representation of FIG. 2 is a significantly simplified representation of an actual blood product management system 16. Those skilled in the art should understand that such a device has many other physical and functional components, such as central processing units, other packet processing modules, and short-term memory. Accordingly, this discussion is in no way intended to suggest that FIG. 2 represents all of the elements of a blood processing management system 16.

As shown, in addition to the image system 10 (described above), the management system 16 of this embodiment has an interface 18 to communicate each of its components with exterior components/devices, and memory 20 for storing information relating to control of the system and/or information relating to the vials 14, container 12, and/or blood product stored in the vials 14.

The interface 18 may simply be considered a generic means for communicating with other devices. More specifically, in some embodiments, the interface 18, is configured to connect to display devices (e.g., display 24), which could range from simple LED screens to sophisticated graphical user interfaces on computer monitors, allowing users to visualize and interact with the system's data and operations in real-time. The adaptability of the interface 18 ensures compatibility with various display technologies, ensuring a seamless and user-friendly experience.

Furthermore, the interface 18 may extend its connectivity to encompass both local and/or wide area networks, enabling robust data exchange and control capabilities over these networks. This includes the ability to integrate with local area networks (LANs) within a confined space, like an office or a building, facilitating swift and secure intra-organizational communication. In a similar manner, it also may be equipped to connect to wide area networks (WANs), which could include the Internet or larger scale corporate networks, thus enabling remote access and control. This feature can be particularly important for managing operations over geographically dispersed locations or for integrating with other remote devices and systems, ensuring that the management system 16 remains interconnected and operable from virtually anywhere, enhancing its efficiency and scope of application.

As noted, the memory 20 may serve as a repository for a diverse range of data essential for both system operation and the tracking of specific contents, such as vials 14, containers 12, and blood products. Part of the memory 20 thus may be allocated for storing control-related information of the management system 16. This can include firmware, which is the low-level software that directly controls the hardware of the system. It also can store system operating parameters, configuration settings, and control algorithms that dictate how the system operates under various conditions. This data manages proper system functioning, enabling it to respond accurately to user commands and automate certain processes. The memory 20 also can log operational data, such as system performance metrics, error logs, and usage statistics, which are vital for maintenance, troubleshooting, and system optimization.

Another portion of the memory 20 may be dedicated to storing information about the vials 14, the container 12, and/or the blood products contained within the vials 14. This may include a database of vial identification indicia and their numbers, their respective positions within the container 12, and specific details about each blood product, like type, volume, collection date, and expiration date. Additionally, the memory 20 could store a history/log of vial movement and handling, effectively tracking data critical for quality assurance and compliance with regulatory standards. This information frequently is important for inventory management, ensuring the integrity of the blood products, and facilitating efficient retrieval and utilization of the vials 14. As noted, the memory 20 can be local to the management system 16, remote from the management system 16, or split between local and remote locations.

In accordance with illustrative embodiments, the management system 16 includes the above noted data verification tool 22 configured to reconcile data related to the vials 14 at one or more points during the transport process (either before transport, during transport, or after receipt), and/or determine a quality of the blood product in the vials 14.

Generally speaking, as known by those in the art, a data verification tool 22 is a specialized and configurable application/tool designed to ensure the accuracy, consistency, and reliability of data within a system. At its core, this tool functions by cross-checking data entries against predefined rules, baseline records, or standards to identify discrepancies, errors, or anomalies. The tool typically incorporates a range of algorithms and validation checks, which can include format checks, consistency checks, range checks, and completeness checks. For instance, it can verify if a date field contains an actual date, or if a numerical entry falls within an expected range. In various embodiments, the data verification tool 22 is coupled with an input to the management system 16 (e.g., via the interface 18) in order to receive image information, etc., from the image system 10.

In illustrative embodiments, the data verification tool 22 can automate the process of data validation and reconciliation, thereby reducing the likelihood of human error and increasing the efficiency of data processing. Automation in data verification in this embodiment can involve scanning large volumes of data and flagging any inconsistencies or errors for review. The inventors recognized that this is particularly important in the blood product transport industry to more rapidly process the blood products for transportation. It also is important where vast amounts of data are processed, and manual verification is impractical or prone to errors. Advanced tools may also employ machine learning techniques to learn from historical data, enhancing their ability to detect anomalies that deviate from established patterns. This capability is especially valuable in predictive analytics, fraud detection, and data-intensive research fields.

Additionally, the data verification tool 22 may be configured to play an important role in maintaining data integrity and quality, which is important for informed decision-making and compliance with regulatory standards. In sectors like finance, healthcare, and e-commerce, where decisions are heavily data-driven and regulatory compliance is critical, the importance of accurate data cannot be overstated. More advanced implementations of the tool 22 also may assist in data cleansing by identifying and rectifying corrupt or inaccurate records, thereby improving the overall quality of the data set. A well-designed data verification tool 22, with robust algorithms and user-friendly interfaces, can be an important asset for an organization dealing with significant amounts of data, and ensuring that the information they rely on is both reliable and actionable.

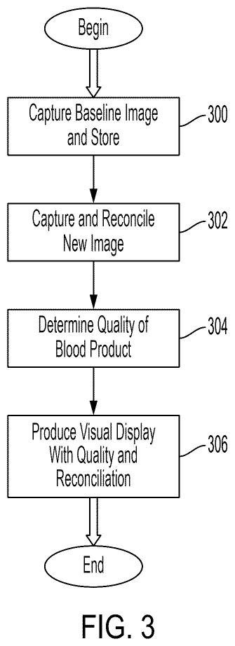

Illustrative embodiments configure the data verification tool 22 to perform the some or all of the reconciliation process summarized in FIG. 3. This configuration does not necessarily require all the functionality potentially available in some data verification tools. Instead, in illustrative embodiments, the tool is customized/configured to perform primarily the functions of FIG. 3. Indeed, some embodiments may borrow further functionality to enhance the process.

The management system 16 may also include a data capture tool 26. Generally, in blood processing data capture tools may automate the collection, extraction, and management of data related to donations and may utilize Optical Character Recognition (OCR) and Al technologies to automatically capture data. This automation may tend to reduce manual data entry and minimizes errors, making the process more efficient and accurate.

In various embodiments, data capture tools may integrate extracted data into existing electronic health records (EHR) systems, to ensure that patient information is easily accessible and up-to-date. Additionally, data security measures associated with data capture tools may serve to protect sensitive information, ensuring compliance with healthcare regulations.

In blood donation centers, data capture tools may track each donation and samples of donations (e.g., for testing) through the entire process, from collection to processing and storage. This tracking ensures consistency and control, helping healthcare professionals focus on more critical tasks and reducing administrative workload and operational costs.

In various embodiments, the data capture tool 26 may produce records after receiving a baseline image of a container removably holding the plurality of vials and then populate any associated record based on the baseline image.

It should be noted that this process of FIG. 3 is substantially simplified from a longer process that normally would be used to register and manage vials 14 of blood product. Accordingly, the process can have many additional steps that those skilled in the art likely would use. In addition, some of the steps may be performed in a different order than that shown, or at the same time. Those skilled in the art therefore can modify the process as appropriate. Moreover, as noted above and below, specific sub-processes and structures noted are but one of a wide variety of different sub-processes and structures that may be used. Those skilled in the art can select the appropriate sub-processes and structures depending upon the application and other constraints. Accordingly, discussion of specific sub-processes and structures is not intended to limit all embodiments.

The process of FIG. 3 begins at step 300, in which the image system 10 captures a baseline image of the container 12 and vials 14 (or an image of just the vials 14), and stores relevant information in a database or other structure in memory 20. In various embodiments, the data capture tool 26 may receive the baseline image and produce a donor record based upon the baseline image. In preferred embodiments, this imaging occurs for each vial 14 in the container 12 at the same time—simultaneously. To form the database, prior to or during this step, the data verification tool 22 analyzes the visual indicia of the vials 14 captured by the image system 10 to produce identifying information for each imaged vial 14. This information then may be associated with the specific container 12 and stored in a database. Some embodiments also may store more information in the database, such as the location of the vial 14 relative to others in the container 12. This information may then be added to a manifest as a baseline record that is used to verify the identity of the vials 14.

In various embodiments, the data verification tool 22 may compare captured identifying indicia of each vial to a record having vial information associated with the container 12.

In alternative embodiments, the unique visual indicia then may be associated with more specific information relating to its associated blood product and/or vial 14. For example, such information may include donor dentification, blood type, volume, data of collection, expiration date, storage conditions, testing information, handling instructions, transport information and timing, product type and processing, destination or use, owner of the vial 14, etc. Among other ways, this association may be manually entered into the database and/or automated in some way. For example, after imaging the seven vials 14 of FIG. 1, the verification tool 22 may enter seven unique identification data into the database. Then, for each vial 14 with identification data in the data base, personnel or automated technology may enter information deemed important to the blood product and its transport. This initial step thus forms a baseline record for a manifest, which is a useful tool for tracking each vial 14 during the transport process.

In some embodiments, the baseline image and related database may be formed with a different system (e.g., manually vial-by-vial 14 or some other mechanism). As discussed below, this database has the baseline information for reconciling the vials 14 during the transport process. For example, the data verification tool 22 may use captured identifying indicia and vial information in the associated record to reconcile the container and plurality of vials to produce a reconciliation.

At some later time, the image system 10 then captures a new image of the vials 14 in the container 12, and uses the scanned visual indicia to reconcile the vials 14 with the data of the baseline manifest and/or database (step 302). For example, the verification tool 22 may check the baseline database or manifest to confirm that this specific container 12 (which also may have a unique identifier) contains the scanned vials 14. Other embodiments may simply confirm that the plurality of scanned vials 14 are in the same container 12, obviating the need to determine a specific identity of the container 12 itself.

The verification tool 22 also may be configured to use that same image to determine a quality of the blood product (step 304). For example, the color of the blood product may be indicative of some quality of the blood. More specifically, the color of a vial 14 of blood product can provide important insights into its quality, composition, and even its suitability for use based on age. Different blood products exhibit characteristic colors that can indicate their state and potential issues. For example, whole blood typically displays a deep red color due to the red blood cells, while plasma is usually straw-colored or pale yellow. Any deviation from these expected hues can be a red flag. If plasma appears pinkish or reddish, it might suggest contamination with red blood cells, often due to improper handling or processing. A darker, brownish tint in plasma can indicate oxidation or degradation, possibly due to prolonged storage or exposure to inappropriate conditions.

The color of blood products can also indicate the presence of certain medical conditions in the donor. In cases of high bilirubin levels, typically associated with liver dysfunction, the plasma may appear more yellow or brownish. This color change is due to the increased concentration of bilirubin, a byproduct of red blood cell breakdown. Additionally, the presence of hemolysis, where red blood cells are broken down, can impart a reddish tint to plasma or serum. Such changes are flags as they can impact the suitability of the blood product for transfusion or other medical uses.

The age of the blood product also is an important factor in its viability and safety, and color can be a key indicator of this. Over time, blood products can undergo physical and chemical changes. For instance, older blood may appear darker due to the breakdown of red blood cells and the release of hemoglobin. This process, known as hemolysis, can impart a reddish hue to plasma or serum, signaling that the blood may be too old and potentially unsafe for transfusion. Similarly, in plasma, a deepening of the yellow color beyond the typical straw shade can suggest aging or exposure to certain conditions that may compromise its quality. Thus, assessing the color of blood products is an important part of the quality control process in blood banks and healthcare facilities. It provides a rapid, initial indication of the product's age and integrity, guiding further testing and decision-making regarding its clinical use.

Rather than relying on the qualitative observation of a technician, step 304 preferably has a database of color ranges and potential issues and/or qualities of blood—e.g., blood product is contaminated, too old, was exposed to high temperatures, etc. The verification tool 22 (or related tool, which also may be considered a verification tool 22) can be configured to perform this function to ensure the quality of the blood product during the transport process. The results can be stored in the database for subsequent use.

The process concludes at step 306, which produces a visual display with the quality and/or the reconciliation results and forward the visual display toward a display device (e.g., display 24). This display (on a display device, such as an LCD monitor) may take on any of a variety of formats. For example, a photograph of the container 12 with the samples may be displayed. If the reconciliation fails (e.g., one vial 14 is not listed in the baseline or manifest as being with the other vials 14 and/or the specific container 12), then the system may display indicators on the photograph identifying the incorrect samples (i.e., failing vials 14) in the container 12. For example, the correct samples may be highlighted in green while the incorrect samples may be highlighted in red. Vials 14 having specified qualities (e.g., contaminated plasma) also may be highlighted on the display.

In addition to or rather than displaying the reconciliation and quality results, some embodiments merely send information to a technician and/or record the results in the database.

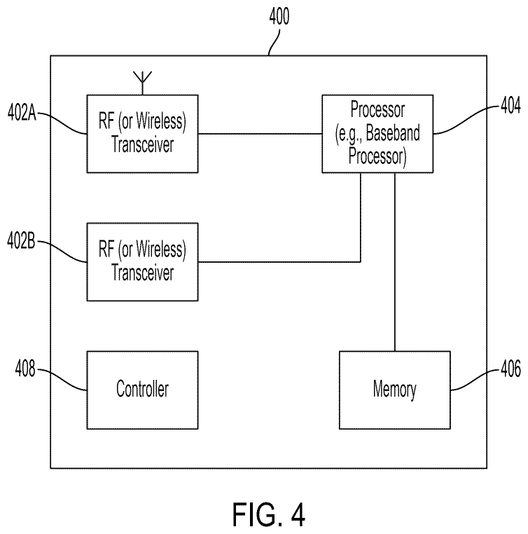

FIG. 4 is an example block diagram of a device 400 in accordance with illustrative embodiments. In various embodiments, the device 400 may be any one of, or part of, the devices depicted in FIG. 2 and may be a wired or wireless device. For purposes of example, device 400 is depicted as a wireless device in FIG. 4.

In various embodiments, the device 400 may include, for example, one or more (e.g., two as shown in FIG. 4) RF (radio frequency) or wireless transceivers 402A, 402B, where each wireless transceiver includes a transmitter to transmit signals and a receiver to receive signals. The device 400 also includes a processor or control unit/entity (controller) 404 to execute instructions or software and control transmission and receptions of signals, and a memory 406 to store data and/or instructions. In various embodiments, the device 400 may incorporate any of the components shown above in FIG. 2.

Processor 404 may also make decisions or determinations, generate frames, packets or messages for transmission, decode received frames or messages for further processing, and other tasks or functions described herein. Processor 404, which may be a baseband processor, for example, may generate messages, packets, frames or other signals for transmission via wireless transceiver 402 (402A or 402B). Processor 404 may control transmission of signals or messages over a wireless network, and may control the reception of signals or messages, etc., via a wireless network (e.g., after being down-converted by wireless transceiver 402, for example). Processor 404 may be programmable and capable of executing software or other instructions stored in memory or on other computer media to perform the various tasks and functions described above, such as one or more of the tasks or methods described above. Processor 404 may be (or may include), for example, hardware, programmable logic, a programmable processor that executes software or firmware, and/or any combination of these. Using other terminology, processor 404 and transceiver 402 together may be considered as a wireless transmitter/receiver system, for example.

In addition, referring to FIG. 4, a controller (or processor) 408 may execute software and instructions, and may provide overall control for the station 400, and may provide control for other systems not shown in FIG. 4, such as controlling input/output devices (e.g., display, keypad), and/or may execute software for one or more applications that may be provided on wireless device 400, such as, for example, an email program, audio/video applications, a word processor, a Voice over IP application, or other application or software.

In addition, a storage medium may be provided that includes stored instructions, which when executed by a controller or processor may result in the processor 404, or other controller or processor, performing one or more of the functions or tasks described above.

According to another example embodiment, RF or wireless transceiver(s) 402A/402B may receive signals or data and/or transmit or send signals or data. Processor 404 (and possibly transceivers 402A/402B) may control the RF or wireless transceiver 402A or 402B to receive, send, broadcast or transmit signals or data.

Example embodiments are provided or described for each of the example methods, including: An apparatus (e.g., 400, FIG. 4) including means (e.g., processor 404, RF transceivers 402A and/or 402B, and/or memory 406, in FIG. 4) for carrying out any of the methods; a non-transitory computer-readable storage medium (e.g., memory 406, FIG. 4) comprising instructions stored thereon that, when executed by at least one processor (processor 404, FIG. 4), are configured to cause a computing system (e.g., 400, FIG. 4) to perform any of the example methods; and an apparatus (e.g., 400, FIG. 4) including at least one processor (e.g., processor 404, FIG. 4), and at least one memory (e.g., memory 406, FIG. 4) including computer program code, the at least one memory (406) and the computer program code configured to, with the at least one processor (404), cause the apparatus (e.g., 400) at least to perform any of the example methods.

Various embodiments of the invention may be implemented at least in part in any conventional computer programming language. For example, some embodiments may be implemented in a procedural programming language (eg., “C”), or in an object-oriented programming language (eg., “C++”). Other embodiments of the invention may be implemented as a pre-configured, stand-alone hardware element and/or as preprogrammed hardware elements (eg., application specific integrated circuits, FPGAS, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (eg., a diskette, CD-ROM, ROM, solid state drive, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (eg., shrink wrapped software), preloaded with a computer system (eg., on system ROM or fixed disk), or distributed from a server or electronic bulletin board over the network (eg., the Internet or World Wide Web). In fact, some embodiments may be implemented in a software-as-a-service model (“SAAS”) or cloud computing model. Of course, some embodiments of the invention may be implemented as a combination of both software (eg., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A method for managing blood products, the method comprising:
using an image system to capture an image of a container removably holding a plurality of vials containing a blood product, each vial having vial identifying indicia, the image system capturing the vial identifying indicia of each vial, the image system also capturing a visual attribute of the blood product;
comparing the captured identifying indicia of each vial to a record having vial information related to the container;
using the captured identifying indicia and vial information in the record to reconcile the container and plurality of vials to produce a reconciliation;
determining a quality of the blood product as a function of the captured visual attribute;
logically producing a visual display of the results of the reconciliation and the quality of the blood product; and
forwarding the visual display toward a display device.

2. The method of claim 1 further comprising:
using the image system to capture a baseline image of the container removably holding the plurality of vials; and
populating the record with the captured image from the other image,
both acts of using the image system to capture the baseline image and populating occurring before reconciling.

3. The method of claim 1 wherein the blood product is plasma.

4. The method of claim 1 further comprising displaying the visual display on the display device.

5. The method of claim 1 wherein the visual display is configured to visually identify vials that are deemed to fail during reconciliation.

6. The method of claim 5 wherein a vial deemed to fail during reconciliation is visually different in the visual display than a vial not deemed to fail during reconciliation.

7. The method of claim 1 wherein the image comprising the container includes at least two or more of the plurality of vials.

8. The method of claim 1 wherein the identifying indicia comprises a bar code or quick response (QR) code.

9. A blood-product management system comprising:
an input configured to receive a captured image from an image system, the captured image including a plurality of vials containing a blood product removably in a container, each vial having vial identifying indicia, the captured image having vial identifying indicia of each vial, the captured image also including a visual attribute of the blood product;
a data verification tool operatively coupled with the input, the data verification tool configured to:
compare the captured identifying indicia of each vial to a record having vial information related to the container,
use the captured identifying indicia and vial information in the record to reconcile the container and plurality of vials to produce a reconciliation,
determine a quality of the blood product as a function of the captured visual attribute, and
logically produce a visual display of the results of the reconciliation and the quality of the blood product; and
forward the visual display toward a display device.

10. The system of claim 9 further comprising:
a data capture tool configured to produce the record after receiving a baseline image of the container removably holding the plurality of vials and then populating the record.

11. The system of claim 9 wherein the blood product is plasma.

12. The system of claim 9 further comprising the image system and a display device to display the visual display.

13. The system of claim 9 wherein the visual display is configured to visually identify vials that are deemed to fail during reconciliation.

14. The system of claim 9 wherein a vial deemed to fail during reconciliation is visually different in the visual display than a vial not deemed to fail during reconciliation.

15. The system of claim 9 wherein the image comprising the container includes at least two or more of the plurality of vials.

16. The system of claim 9 wherein the identifying indicia comprises a bar code or quick response (QR) code.

17. A computer program product for use on a computer system managing blood product data, the computer program product comprising a tangible, non-transient computer usable medium having computer readable program code thereon, the computer readable program code comprising:
program code for controlling an image system to capture an image of a container removably holding a plurality of vials containing a blood product, each vial having vial identifying indicia, the image system capturing the vial identifying indicia of each vial, the image system also capturing a visual attribute of the blood product;
program code for comparing the captured identifying indicia of each vial to a record having vial information related to the container;
program code for using the captured identifying indicia and vial information in the record to reconcile the container and plurality of vials to produce a reconciliation;
program code for determining a quality of the blood product as a function of the captured visual attribute;
program code for logically producing a visual display of the results of the reconciliation and the quality of the blood product; and
program code for forwarding the visual display toward a display device.

18. The computer program product of claim 17 further comprising:
program code for using the image system to capture another image of the container removably holding the plurality of vials; and
program code for populating the record using the capture of the other image,
both acts of using the image system to capture another image and populating occurring before reconciling.

19. The computer program product of claim 17 wherein the blood product is plasma.

20. The computer program product of claim 17 further comprising program code for displaying the visual display on the display device.

21. The computer program product of claim 17 wherein the visual display is configured to visually identify vials that are deemed to fail during reconciliation.

22. The computer program product of claim 17 wherein a vial deemed to fail during reconciliation is visually different in the visual display than a vial not deemed to fail during reconciliation.

23. The computer program product of claim 17 wherein the image comprising the container includes at least two or more of the plurality of vials.

24. The computer program product of claim 17 wherein the identifying indicia comprises a bar code or quick response (QR) code.
